(19) United States
(12) Patent Application Publication
(10) Pub. No.: US 2015/0088502 A1
(43) Pub. Date: Mar. 26, 2015

(54) Voice Recognition System For Interactively Gathering Information To Generate Documents

(71) Applicant: Voicefill LLC, Pasadena, CA (US)

(72) Inventor: Kenneth Barash, Del Ray Beach, FL (US)

(73) Assignee: Voicefill LLC, Pasadena, CA (US)

(21) Appl. No.: 14/038,564

(22) Filed: Sep. 26, 2013

(51) Int. Cl. G10L 15/26; G06F 17/28

(52) U.S. Cl. CPC G10L 15/26; G06F 17/28
USPC 704/235; 704/2

(57) ABSTRACT

A voice recognition system for interactively gathering information to generate a document, form, or application. An user establishes a connection with the voice recognition system and provides verbal responses to a plurality of verbal questions generated by voice recognition system to compile a document, form or application. The voice recognition system converts the user's verbal responses to textually converted responses.

### CROSS-REFERENCE

This application is a continuation of U.S. patent application Ser. No. 12/617,584, filed on Nov. 12, 2009, which is continuation-in-part application of U.S. application Ser. No. 11/974,105, which is a continuation of Ser. No. 10/814,905, now abandoned, which is a continuation of U.S. application Ser. No. 09/828,087, now U.S. Pat. No. 6,738,740, which claims benefit to U.S. Provisional patent Application Ser. No. 60/208,373 filed May 31, 2000, each which is incorporated herein by reference in its entirety.

### BACKGROUND

The claimed invention relates to method and system for gathering information to generate a document. More specifically, the claimed invention relates to a voice recognition system for interactively gathering information to generate a document.

For example, the mortgage application process has always been and remains a process that most people fear and dread. The process of gathering the necessary information for most applicants is a torturous procedure from inception to the end. Unfortunately, most information gathers or compilers are not skilled or trained properly to correctly explain the mortgage process to the applicants and collect the necessary information to complete the mortgage application form. As a result, many mortgage applications submitted for processing are incomplete leaving the applicants continually searching for additional supporting documents or explanations. Of course, this tedious process could have been avoided if the applicants were properly informed of the mortgage process. All of this contributes to making the mortgage process a nightmare.

Even with the advent of the Internet, the mortgage process has not become any easier or less pressured in spite of all of the hype and claims associated with the web based products and services. The applicant is still not in control of the process and does not have a complete understanding of the process.

Accordingly, the claimed invention proceeds upon the desirability of providing a system that simplifies the process, i.e., information gathering process, while at the same time educating the consumer (user or applicant) about the process. The voice recognition system (VRS) of the claimed invention interactively gathers information from the user to create the necessary documents and forms. For example, the VRS of the claimed invention insures a faster approval of the credit application and is more cost effective to all parties involved in the transaction, such as the consumer, the creditor and all third party providers. Additionally, the VRS system of the claimed invention advantageously provides the convenience of data entry by voice.

### SUMMARY

Therefore, it is an object of the claimed invention to provide a voice recognition system and technique for interactively gathering information from the user to generate documents.

Another object of the claimed invention is to provide the voice recognition system and technique as aforesaid, which stores partially completed document to enable a user to complete the incomplete document at a later time.

A further object of the claimed invention is to provide the voice recognition system and technique as aforesaid, which generates credit investigation documents.

Still another object of the claimed invention is to provide the voice recognition system and technique as aforesaid, which relays the completed credit investigation documents to a third party underwriting system, such as a lender, Fannie Mae, Freddie Mac, FNMA, FHLMC, PMI, etc.

Yet another object of the claimed invention is to provide the voice recognition system and technique as aforesaid, which stores the applicant's information, such as personal, financial, etc., that can be accessible only by the applicant to generate other documents.

Still yet another object of the claimed invention is to provide the voice recognition system and techniques as aforesaid, which interactively gathers information in one language and generates a document in another language.

In accordance with an exemplary embodiment of the claimed invention, a voice recognition system (VRS) for interactively gathering information from a plurality of users over a communications network comprises an interface unit, a processor and a storage device. The interface unit receives connection requests from a plurality of remote devices over the communications network to access or connect to the VRS. The processor transmits a plurality of verbal questions interactively to a remote device associated with a user to complete a textual document when the interface unit establishes a connection with the remote device associated with the user over said communications network. The processor captures user's verbal responses to the plurality of questions and converts the user's verbal responses into textually converted responses of the user. The storage device stores the user's verbal responses to the plurality of questions captured by the processor and the textually converted responses of the user.

In accordance with an exemplary embodiment of the claimed invention, a computer readable medium comprises computer executable code for interactively gathering information from a plurality of users over a communications network. The computer executable code comprises instructions for receiving connection requests by an interface unit of a voice recognition system (VRS) from a plurality of remote devices over the communications network to access or connect to the VRS; transmitting a plurality of verbal questions interactively by a processor of the VRS to a remote device associated with a user to complete a textual document when the interface unit establishes a connection with the remote device associated with the user over the communications network; capturing user's verbal responses to the plurality of questions by the processor; converting the user's verbal responses into textually converted responses of the user by the processor; and storing the user's verbal responses to the plurality of questions captured by the processor and the textually converted responses of said user in a storage device.

Various other objects, advantages and features of the claimed invention will become readily apparent from the ensuing detailed description, and the novel features will be particularly pointed out in the appended claims.

### BRIEF DESCRIPTION OF THE DRAWINGS

The following detailed description, given by way of example, and not intended to limit the claimed invention solely thereto, will best be understood in conjunction with the accompanying drawings:

FIG. 1 is a flow chart describing the operation of the claimed invention; and

FIG. 2 is a block diagram of the communications network which incorporates the voice recognition system in accordance an exemplary embodiment of the claimed invention.

### DETAILED DESCRIPTION OF THE EMBODIMENTS

The voice recognition system (VRS) 1000 of the claimed invention is applicable to the mortgage industry as well as any other industry or any governmental agency (federal, state and local) that requires an individual or business to complete forms, such as credit investigation documents, school application, professional application (i.e., bar application, etc.), governmental forms (immigration/visa forms, income tax returns, etc.). Until, now, the credit investigation for personal approval has been a long, tedious, stressful and inefficient process for most people. The process requires many levels of personnel, from telephone clerks, processors, underwriters, reviewers, closers and management to supervise all of those mentioned.

With the advent of technology and standardization of forms to complete the application, the claimed invention utilizes a voice recognition system 1000 to provide a new process enabling a company to interactively gather the necessary information from people or business to complete the forms with ease and control. That is, the application process, such as the mortgage application process, is totally under the applicant control. The applicant can use the voice recognition system 1000 when it is convenient for him and not when it is convenient for the mortgage company, lender or bank. Also, the voice recognition system 1000 of the claimed invention enables the company to replace their current cumbersome, costly and labor intensive process with this convenient and efficient service/process at a lower cost. In other words, the voice recognition system 1000 of the claimed invention may enable companies to automate the process by eliminating unnecessary levels of personnel, thereby creating a more efficient and less costly process.

It is appreciated that the voice recognition system 1000 of the claimed invention may utilize any voice recognition technology to interactively gather information from users to generate documents. Any person or business located anywhere in the world may utilize the voice recognition system 1000 of the claimed invention for any product or service requiring documents, forms or applications.

The claimed invention is readily implemented by presently available communication apparatus and electronic components. The invention finds ready application in virtually all communication networks that supports voice transmission and integrated reception, including but not limited to the telephone network, wireless network, satellite network, cable network, computer network (i.e., the Internet), etc. Also, the invention finds ready application in virtually all voice input devices connected to one of the above networks, including but not limited, the land telephone, the cellular phone, computer, a network enabled portable device and other remote access devices.

In accordance with an embodiment of the claimed invention, the voice recognition system 1000 of the claimed invention is available twenty-four (24) hours a day, seven (7) days a week. Preferably, each user or client (a person or company) is assigned a pin number (or user id) before initiating the system of the claimed invention to complete a document, application or form. Alternatively, the system of the claimed invention records voice identification of each client, thereby permitting the client to securely access and complete his or her document, application or form. If the client does not complete the application during the session, the pin number, voice identification or other identification means will enable the client to access the uncompleted application and finish the uncompleted application in a secured manner. That is, the client can continue with the application from his/her last stopping point over a voice connection using the voice recognizer system. This advantageously eliminates the necessity of starting the application all over from the beginning.

In accordance with an embodiment of the claimed invention, the voice recognition system provider or operator converts the uncompleted verbal application into a textual document (i.e., partially completed application) and makes the partially completed application available on a provider's website for completion by the user or client. That is, the client can continue with the application from his/her last stopping point on the website.

In accordance with an embodiment of the claimed invention, the voice recognition system provider or operator provides an option to enable the client or user to continue with the application either over the voice connection using the voice recognition system 1000 or on a website. If the user or client selects the website option, then the voice recognition system 1000 converts the uncompleted verbal application into a textual document (i.e., partially completed application). That is, the client can continue with the application form his/her last stopping point either over the voice connection using the voice recognition system 1000 or on a provider's website. Preferably, the voice recognition system 1000 additionally provides information regarding the website, such as the website's address, that he or she can access to complete the application.

In accordance with another embodiment of the claimed invention, the applicant can complete another application or form (i.e., in connection with another service or product, another credit application) by simply accessing and modifying the previously completed application, document or form in a secure manner, for example using an assigned pin number, voice identification or other comparable means. That is, the applicant does not need to complete another application from scratch or re-enter information already provided in connection with another application. For example, the applicant's information, such as address, phone number, employer and the like, can be automatically extracted (retrieved) from existing application to complete another application.

In accordance with an aspect of the claimed invention, the voice recognition system 1000 of the claimed invention permits user to interrupt the information gathering process with questions. That is, the voice recognition system 1000 of the claimed invention can answer questions verbally posed by the applicant or user, thereby providing immediate assistance to the applicant and resulting in greater percentage of successfully completed application. Preferably, the system of the claimed invention is capable of detecting when an applicant is having a difficulty with a particular question or a particular section of the application, such as an extensive delay in providing the answer, use of the expression “ugh,” or the like. Additionally, if the applicant enters an incorrect or ambiguous information, the voice recognition system 1000 of the claimed invention can take steps to correct such incorrect or ambiguous information, such as editing the information based on other available information, request the applicant for correct information, explain to the applicant what is being asked for, ask for clarification or confirmation, such as when applicant responds with “same or ditto,” etc.

In accordance with another aspect of the claimed invention, the voice recognition system 1000 supports multiple languages. That is, the voice recognition system 1000 of the claimed invention can interactively gather information from the user using one language and generate a document, form, application, etc. in another language, such as interact with the client in Spanish and generate a complete application in English, German, French, etc. For example, a person in Japan or a Japanese speaker in U.S. can select to interact in Japanese with the voice recognition system 1000 of the claimed invention to complete a mortgage application in English for a house in New York. Preferably, the voice recognition system 1000 of the claimed invention answers client's or applicant's questions in client's chosen or selected language.

In accordance with an embodiment of the claimed invention, at any time during the application process, the client may opt or choose to speak with a live operator for a particular question or for additional assistance and then return to automated application process to complete the application. Alternatively, the client may select to continue the application process with a live operator.

After the completion of the information gathering process (i.e., a voice application), the voice recognition system 1000 converts and/or translates the voice application to a textual document or application including any mathematical calculations, attachments, appendix, supporting documents, etc. Preferably, the voice recognition system 1000 can also translate, if necessary, the voice application in one language to a textual application in another language. The textual application can then be stored or electronically transmitted or downloaded to a third party, financial institution, mortgage broker or a specific or predetermined provider for processing or automated credit approval, such as Fannie Mae, Freddie Mac, etc., within minutes. Approvals include all required information to meet any Federal, state, local or regulatory compliance. Preferably, the VRS 1000 notifies applicant and service provider simultaneously by means of voice, print or electronically.

In accordance with an embodiment of the claimed invention, after the voice recognition system 1000 converts and/or translates the voice or verbal application to a textual document or application (including any mathematical calculations, attachments, appendix, supporting documents, etc.), the voice recognition system 1000 makes the completed application or textual document available on a provider's website. The completed application can be reviewed for accuracy by the user or client before the application is processed by the voice recognition system 1000 operator/provider or other third party operator/provider.

The voice recognition system 1000 of the claimed invention can be utilized in any industry, governmental or commercial, where forms, applications and/or other documents needs to be completed. For example, the claimed invention finds ready application in many industries, including but not limited to financial, brokerage account, credit card, mortgage, automotive, boat, equipment leasing, tax return, law, insurance, immigration, academia (i.e., school or college applications), etc. Converting voice into text is a giant leap in technology and is vital to this process.

Additionally, the voice recognition system 1000 of the claimed invention prepares and generates all supporting documents to meet each specific requirement of a particular application. These supporting documents can be sent electronically or by other means for review and signature by the applicant if required by the service provider, i.e., lender.

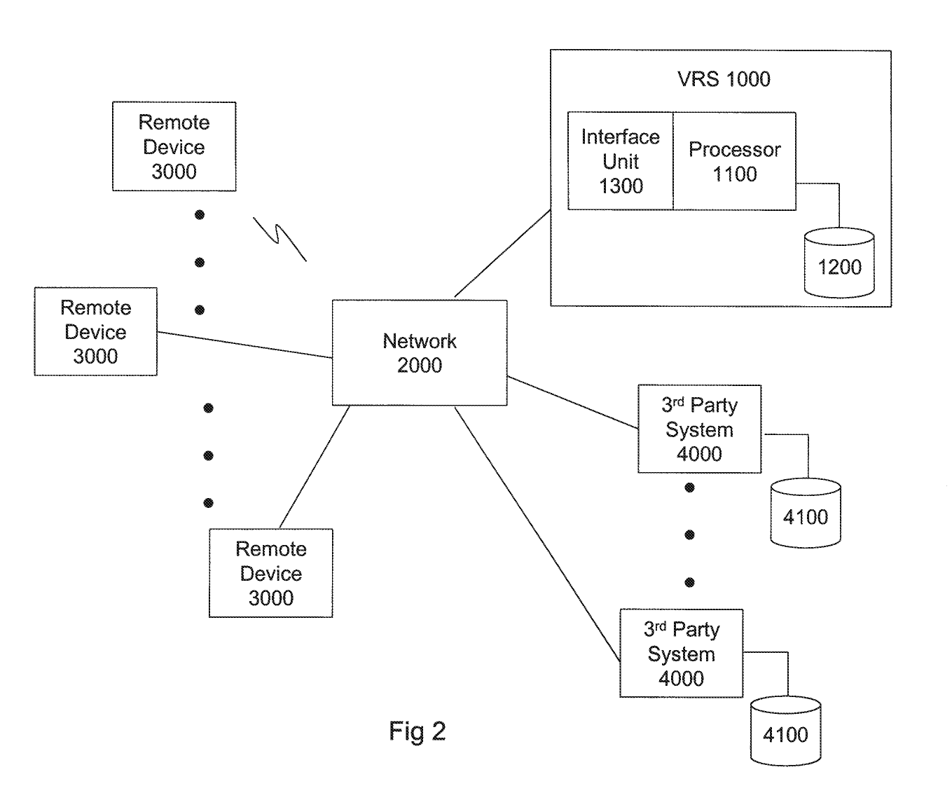

In accordance with an exemplary embodiment of the claimed invention, as shown in FIG. 2, a voice recognition system (VRS) 1000 for interactively gathering information from a plurality of users over a communications network 2000 comprises an interface unit 1300, a processor 1100 and a storage device or database 1200. The interface unit 1300 receives connection requests from a plurality of remote devices 3000 over the communications network 2000 to access or connect to the VRS 1000. The processor 1100 transmits a plurality of verbal questions interactively to a remote device 3000 associated with a user to complete a textual document when the interface unit 1300 establishes a connection with the remote device 3000 associated with the user over said communications network 2000. The processor 1100 captures user's verbal responses to the plurality of questions and converts the user's verbal responses into textually converted responses of the user. The storage device 1200 stores the user's verbal responses to the plurality of questions captured by the processor 1100 and the textually converted responses of the user. Preferably, the processor completes the textual document based on the textually converted responses of the user.

In accordance with an aspect of the claimed invention, the processor 1100 of the VRS 1000 can transmit the completed textual document to the remote device 3000 associated with the user for confirmation or execution over the communications network 2000.

In accordance with an aspect of the claimed invention, instead of completing the textual document, the interface unit 1300 of the VRS 1000 can transmit the textually converted responses of the user and/or the user's verbal responses to a third party system 4000 over the communications network. The VRS 1000 can transmit user's verbal responses and textually converted responses as raw, unformatted data or as formatted data suitable for a particular application. The third party system 4000 can store the received textually converted responses and/or the user's verbal responses in a storage device or database 4100. The third party can generate the textual document based on the textually converted responses of the user received by the third party system 4000. Additionally, the third party can generate one or more different textual documents based on the store textually converted responses of the user.

In accordance with an exemplary embodiment of the claimed invention, the processor 1100 can receive the user's verbal responses to the plurality of questions in one language and convert the user's verbal responses into the textually converted responses in another language. That is, user responds in Spanish and the VRS 1000 convu is the Spanish verbal responses to English text. The processor 1100 of the VRS 1000 can complete the textual document based the textually converted responses (i.e., English text representing user's verbal responses in Spanish) or can transmit the textually converted responses to the third party system 4000 for processing over the communications network 2000.

In accordance with an exemplary embodiment of the claimed invention, the processor 1100 of the VRS 1000 can complete a portion or all of a different textual document based on the textually converted responses of the user stored in the storage device 1200. If only a portion of the different textual document can be completed from the stored textually converted responses of the user, the processor 1100 of the VRS 1000 generates additional verbal questions and transmits the additional verbal questions interactively to the remote device 3000 associated with the user to complete remaining portion of the different textual document.

In accordance with an exemplary embodiment of the claimed invention, the textually converted responses of the user stored in the storage device 1200 of said VRS 1000 is accessible by the remote device 3000 associated with the user over the communications network 2000. That is, a user can access on her textually converted responses. Whereas, the third party system 4000 can access all of textually converted responses and verbal responses stored in the storage device 1200 of the VRS 1000 over the communications network 2000. This can represent a hosted scenario, where a company's voice application to a complete a particular form by its customers are hosted by another entity (i.e., the provider of the VRS 1000) and the other entity transmits electronically or by other comparable means its customers' responses (the raw verbal responses and/or textually converted responses) to a series of questions to complete that particular form.

In accordance with an exemplary embodiment of the claimed invention, the computer executable code for interactively gathering information from a plurality of users over a communications network can be downloaded from a website or stored on a tangible computer recordable medium, such as a disk, CD, DVD, flash memory, RAM, ROM, portable storage device and the like. The computer executable code comprises instructions for receiving connection requests by an interface unit of a voice recognition system (VRS) 1000 from a plurality of remote devices 3000 over the communications network 2000 to access or connect to the VRS 1000; transmitting a plurality of verbal questions interactively by a processor 1100 of the VRS 1000 to a remote device 3000 associated with a user to complete a textual document when the interface unit 1300 establishes a connection with the remote device 3000 associated with the user over the communications network 2000; capturing user's verbal responses to the plurality of questions by the processor 1100; converting the user's verbal responses into corresponding textual responses of the user by the processor 1100; and storing the user's verbal responses to the plurality of questions captured by the processor 1100 and the corresponding textual responses of said user in a storage device or database 1200.

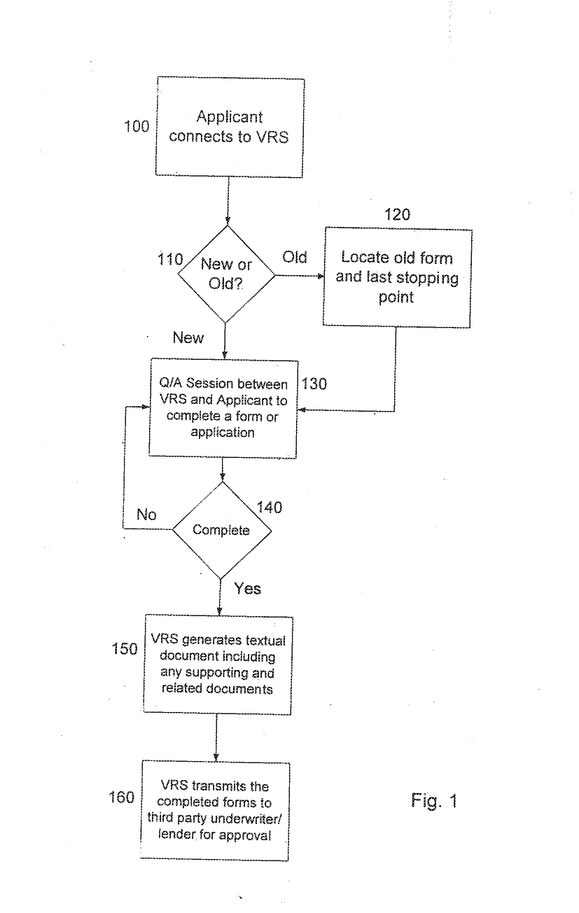

Turning now to FIG. 1, there is illustrated a flowchart describing the process by which an embodiment of the claimed invention generates and process a mortgage application. For example, an applicant can respond to an advertisement and is supplied with a phone number to call, thereby connecting to and utilizing the voice recognition system 1000 (VRS) of the claimed invention at step 100. The VRS 1000 makes an inquiry to determine if the applicant is completing a new application or continuing with an existing application at step 110. If the applicant is completing a new application, the VRS 1000 provides a brief description of required information and proceeds to step 130 to complete a new application. Otherwise or if interrupted or the applicant exits for any reason at any time, the applicant can use of the assigned pin number, voice identification or other comparable means for identifying the applicant to re-enter the system and proceed with the application at the exited point at step 120. The voice recognition system 1000 has the ability to answer questions posed by the client regarding mortgage terminology and can compute and calculate any number associated with the mortgage application, such as the monthly mortgage payment based on the principal of the mortgage or a range of the monthly mortgage payment in accordance with the mortgage rate and/or the term of the mortgage.

The standard documentation required in the mortgage industry is known as the “1003 Form”. This standard form can be used to purchase a property located anywhere in the United States or refinance an existing loan. The 1003 Form was developed by the industry from investors known as the Federal National Mortgage Association, better known as FNMA. The FNMA is a United States government sponsored enterprise that purchases mortgage loans from approved seller services throughout the country. The Federal Home Loan Bank Corp. is another government sponsored enterprise that purchases primary residential mortgage loans in the U.S.

It is well known to those skilled in the art that the standard application forms, mortgage programs, products and disclosures are used by thousands of approved seller service providers.

FNMA and FHLM Corp. have developed an artificial underwriting system to accept loan applications through an electronic submission of its standard application. It pulls the borrower's credit history from designated credit repositories. It then process this credit information using a credit screening system and other internal credit requirements to make a value judgment as to the acceptability or inadequacy of this borrower to meet the monthly financial obligation for this specific mortgage loan. The automated underwriting system can also specify conditions for its acceptability, such as listing all the information required from the borrower to provide the credit approval.

This information is then electronically sent to the designated individual or company as a record for this transaction.

Returning to FIG. 1, the voice recognition system 1000 of the claimed invention interactively gathers the information required in these standard mortgage transactions from the applicant or borrower using a verbal question and answer session to walk the applicant through the application process at step 130. The VRS 1000 then makes an inquiry at step 140 to determine if the information gathering process is complete. If the inquiry is answered in the negative, then VRS 1000 then makes another inquiry at step 145 to determine if the applicant wants to continue completing the application using the VRS 1000 or on a website, preferably on a VRS provider's website. If the applicant elects to continue with the application on the website based on applicant's verbal response, then VRS 1000 of the claimed invention generates incomplete textual document (i.e., incomplete mortgage application) and transmits or downloads the incomplete textual document to the website at step 170. The applicant can then logon on to the website using the password to complete the application at step 180.

However, if the applicant elects to continue with the VRS 1000 based on applicant's verbal response, then VRS 1000 proceeds to step 130 to gather more information from the applicant. If the inquiry at step 140 is answered in the affirmative, based on the applicant's verbal answers or responses, the voice recognition system 1000 of the claimed invention prepares and generates a completed mortgage application and other documents required in a standard mortgage transaction at step 150, including but not limited to:

1) 1005-mortgage summary of required financial information;

2) GFE—Good Faith Estimate—proposed fees and charges borrowers will have to pay prior to or at time of Settlement, such as approval fees, credit report fees, settlement fees;

3) Truth and Lending—Federal form to explain to the borrower the annual % rate of the loan;

4) Product disclosure—type of mortgage loan and how it works;

5) Financing and Lock In Agreement—An agreement pertaining to the interest rate and fees to a specific interest rate to be guaranteed for a specific time and the fee points;

6) State Specific Closing Disclosure—This applies to each specific state;

7) Settlement Agency Disclosure—Specifies as to who will prepared documents and settlement loan proceeds;

8) Approval Disclosures—right to receive a copy of approval report; and

9) List of all settlement providers used in specific mortgage loan for client

In accordance with the claimed invention, the voice recognition system 1000 is operable to assist the applicant in completing this 1003 Form in its entirety along with any supporting documentation as required by investor or lender, and any federal, state and/or local law, regulation or statute. It is appreciated that the voice recognition system 1000 of the claimed invention may compute certain entries in the form or application using predetermined mathematical formula, e.g., calculating the monthly payment based on the principal amount, the term of the loan and interest rate. If incomplete, inaccurate or ambiguous information is provided by the applicant, the voice recognition system 1000 of the claimed invention informs the applicant that the information provided is either incorrect or incomplete. Preferably, the system may additionally provide an explanation or clarification as to the requisite information.

Upon the completing the information gathering process, i.e., the application, the voice recognition system 1000 of the claimed invention transmits the application to a pre-determined automatic underwriting system at step 160. This advantageously permits FNMA/FHLMC/PMI or other third party underwriter/lender to approve the loan in a matter of minutes with/without any conditions. If the borrower application is rejected then the system of the claimed invention can transmit the application to agencies or companies that services risky credit borrowers or impair credit borrowers. Alternatively, the completed application can be printed and mailed, or transmitted electronically, via facsimile or other comparable means to the applicant for verification and/or execution.

In the event a specific mortgage amount is not specified or requested by the applicant, the voice recognition system 1000 of the claimed invention in conjunction with underwriting system provide the maximum amount of mortgage based upon the applicant's information.

The approval can be transmitted to a specific lender or a group of lenders that will provide the applicant with the terms and conditions of the mortgage as requested by the applicant, such as fixed rate or variable rate mortgage. The selected lender will then deal directly with the applicant to complete the transaction. The requisite documents can be exchanged between the applicant and the lender electronically, by fax or by Internet or any other electronic means to complete the transaction. Preferably, the borrower receives copies of all required documents and completes the mortgage process directly with the lender.

By using the voice recognition system 1000 of the claimed invention, the processing time of a mortgage application (including settlement) may be cut in half, thereby benefiting both the applicant (customer) and the lender. Also, the present process is less stressful, easier and not as tedious to the applicant.

Preferably, the applicant can provide or update his/her information to specific lenders in order to obtain additional credit in advance of his/her needs. The voice recognition system 1000 of the claimed invention advantageously streamlines the loan process. The mortgage process has been known to be a tedious hardship on the borrower because he/she has no control over the process and must give up control of his/her personal and financial information.

For example, in the mortgage application case, the system of claimed invention enables direct communication between the borrower and other third parties, such as appraisal company, title company, home insurance company, moving company, etc. If a transaction is established or consummated between the borrower and any one of these third parties, the claimed invention can electronically transmit any required information regarding the borrower to such third party.

While the claimed invention has been particularly described with respect to the illustrated embodiment, it will be appreciated that various alterations, modifications and adaptations may be made based on the present disclosure, and are intended to be within the scope of the claimed invention. It is intended that the appended claims be interpreted as including the embodiment discussed above, those various alternatives, which have been described and all equivalents thereto.

We claim:

1. A voice recognition system (VRS) for interactively gathering information from a plurality of users over a communications network, comprising: an interface unit to receive connection requests from a plurality of remote devices over said communications network to access or connect to said VRS; a processor transmits a plurality of verbal questions interactively to a remote device associated with a user to complete a textual document when said interface unit establishes a connection with said remote device associated with said user over said communications network, captures user's verbal responses to said plurality of questions, and converts said user's verbal responses into textually converted responses of said user; and a storage device stores said user's verbal responses to said plurality of questions captured by said processor and said textually converted responses of said user.

2. The system of claim 1, wherein said interface unit transmits at least one of the following to a third party system over said communications network: said textually converted responses of said user and said user's verbal responses to said plurality of questions.

3. The system of claim 1, wherein said processor completes said textual document based on said textually converted responses of said user.

4. The system of claim 3, wherein said processor transmits said textual document to said remote device associated with said user for confirmation or execution over said communications network.

5. The system of claim 1, wherein said processor receives said user's verbal responses to said plurality of questions in one language and converts said user's verbal responses into said textually converted responses in another language.

6. The system of claim 5, wherein said interface unit transmits said textually converted responses of said user in said other language to a third party system over said communications network.

7. The system of claim 1, wherein said processor utilizes said textually converted responses of said user stored in said storage device to complete a portion or all of a different textual document.

8. The system of claim 7, wherein said processor generates additional verbal questions and transmits said additional verbal questions interactively to said remote device to complete remaining portion of said different textual document.

9. The system of claim 1, wherein said communications network being one of the following: a telephone network, a wireless network, a satellite network, a cable network, a computer network and Internet.

10. The system of claim 1, wherein said remote device being one of the following: a telephone, a cell phone, a network enabled portable device, and a computer.

11. The system of claim 1, wherein said textually converted responses of said user stored in said storage device of said VRS is accessible by said remote device associated with said user over said communications network; and wherein said textually converted responses of said user and said user's verbal responses stored in said storage device of said VRS is accessible by an authorized third party system over said communications network.

12. A computer readable medium comprising computer executable code for interactively gathering information from a plurality of users over a communications network, said computer executable code comprising instructions for: receiving connection requests by an interface unit of a voice recognition system (VRS) from a plurality of remote devices over said communications network to access or connect to said VRS; transmitting a plurality of verbal questions interactively by a processor of said VRS to a remote device associated with a user to complete a textual document when said interface unit establishes a connection with said remote device associated with said user over said communications network; capturing user's verbal responses to said plurality of questions by said processor; converting said user's verbal responses into textually converted responses of said user by said processor; and storing said user's verbal responses to said plurality of questions captured by said processor and said textually converted responses of said user in a storage device.

13. The computer readable medium of claim 12, further comprising instructions for transmitting at least one of the following to a third party system over said communications network: said textually converted responses of said user and said user's verbal responses to said plurality of questions.

14. The computer readable medium of claim 12, further comprising instructions for completing said textual document based on said textually converted responses of said user.

15. The computer readable medium of claim 14, further comprising instructions for transmitting said textual document to said remote device associated with said user for confirmation or execution over said communications network.

16. The computer readable medium of claim 12, further comprising instructions for receiving said user's verbal responses to said plurality of questions in one language and converting said user's verbal responses into said textually converted responses in another language.

17. The computer readable medium of claim 16, further comprising instructions of transmitting said textually converted responses of said user in said other language to a third party system over said communications network.

18. The computer readable medium of claim 12, further comprising instructions for completing a portion or all of a different textual document from said textually converted responses of said user stored in said storage device.

19. The computer readable medium of claim 18, further comprising instructions for generating additional verbal questions and transmits said additional verbal questions interactively to said remote device to complete remaining portion of said different textual document.

20. The computer readable medium of claim 12, further comprising instructions for accessing said textually converted responses of said user stored in said storage device of said VRS by said remote device associated with said user over said communications network; and accessing said textually converted responses of said user and said user's verbal responses stored in said storage device of said VRS by an authorized third party system over said communications network.
